(19) United States
(12) Patent Application Publication
(10) Pub. No.: US 2017/0002119 A1
(43) Pub. Date: Jan. 5, 2017

(54) Reclaimed Polypropylene Composition

(71) Applicant: The Procter & Gamble Company, Cincinnati, OH (US)

(72) Inventors: John Moncrief Layman, Liberty Township, OH (US); Maggie Gunnerson, Cincinnati, OH (US); Eric Bryan Bond, Maineville, OH (US); Hans Schonemann, Newburyport, MA (US); Kara Williams, South Weymouth, OH (US)

(21) Appl. No.: 15/190,240

(22) Filed: Jun. 23, 2016

Related U.S. Application Data
(60) Provisional application No. 62/186,510, filed on Jun. 30, 2015.

(51) Int. Cl. C08F 110/06

(52) U.S. Cl. CPC C08F 110/06

(57) ABSTRACT

A composition is disclosed that comprises at least about 95 weight percent reclaimed polypropylene. The reclaimed polypropylene comprises less than about 10 ppm Al, less than about 5 ppm Ti, and less than about 5 ppm Zn. The reclaimed polypropylene has a contrast ratio opacity of less than about 15% and the composition is substantially free of odor.

### FIELD OF THE INVENTION

The present invention generally relates to composition of reclaimed polypropylene that is sustainably free of odor and heavy metal contamination and having high optical translucency. The reclaimed polypropylene composition is made via a method for purifying reclaimed polypropylene that uses a pressurized solvent and solid media. More specifically, this invention relates to a composition of reclaimed polypropylene made from purifying recycled polypropylene, such as post-consumer and post-industrial recycled polypropylene. The method produces an unexpectedly pure reclaimed polypropylene composition that is colorless or clear, substantially free of odor and heavy metal contamination, and comparable to virgin polypropylene.

### BACKGROUND OF THE INVENTION

Polypropylene, especially synthetic plastics, are ubiquitous in daily life due to their relatively low production costs and good balance of material properties. Synthetic plastics are used in a wide variety of applications, such as packaging, automotive components, medical devices, and consumer goods. To meet the high demand of these applications, tens of billions of pounds of synthetic plastics are produced globally on an annual basis. The overwhelming majority of synthetic plastics are produced from increasingly scarce fossil sources, such as petroleum and natural gas. Additionally, the manufacturing of synthetic plastics from fossil sources produces CO₂ as a by-product.

The ubiquitous use of synthetic plastics has consequently resulted in millions of tons of plastic waste being generated every year. While the majority of plastic waste is landfilled via municipal solid waste programs, a significant portion of plastic waste is found in the environment as litter, which is unsightly and potentially harmful to ecosystems. Plastic waste is often washed into river systems and ultimately out to sea.

Plastics recycling has emerged as one solution to mitigate the issues associated with the wide-spread usage of plastics. Recovering and re-using plastics diverts waste from landfills and reduces the demand for virgin plastics made from fossil-based resources, which consequently reduces greenhouse gas emissions. In developed regions, such as the United States and the European Union, rates of plastics recycling are increasing due to greater awareness by consumers, businesses, and industrial manufacturing operations. The majority of recycled materials, including plastics, are mixed into a single stream which is collected and processed by a material recovery facility (MRF). At the MRF, materials are sorted, washed, and packaged for resale. Plastics can be sorted into individual materials, such as high-density polyethylene (HDPE) or poly(ethylene terephthalate) (PET), or mixed streams of other common plastics, such as polypropylene (PP), low-density polyethylene (LDPE), poly(vinyl chloride) (PVC), polystyrene (PS), polycarbonate (PC), and polyamides (PA). The single or mixed streams can then be further sorted, washed, and reprocessed into a pellet that is suitable for re-use in plastics processing, for example blow and injection molding.

Though recycled plastics are sorted into predominately uniform streams and are washed with aqueous and/or caustic solutions, the final reprocessed pellet often remains highly contaminated with unwanted waste impurities, such as spoiled food residue and residual perfume components. In addition, recycled plastic pellets, except for those from recycled beverage containers, are darkly colored due to the mixture of dyes and pigments commonly used to colorize plastic articles. While there are some applications that are insensitive to color and contamination (for example black plastic paint containers and concealed automotive components), the majority of applications require non-colored pellets. The need for high quality, “virgin-like” recycled resin is especially important for food and drug contact applications, such as food packaging. In addition to being contaminated with impurities and mixed colorants, many recycled resin products are often heterogeneous in chemical composition and may contain a significant amount of polymeric contamination, such as polyethylene (PE) contamination in recycled PP and vice versa.

Mechanical recycling, also known as secondary recycling, is the process of converting recycled plastic waste into a re-usable form for subsequent manufacturing. A more detailed review of mechanical recycling and other plastics recovery processes are described in S. M. Al-Salem, P. Lettieri, J. Baeyens, “Recycling and recovery routes of plastic solid waste (PSW): A review”, Waste Management, Volume 29, Issue 10, October 2009, Pages 2625-2643, ISSN 0956-053X. While advances in mechanical recycling technology have improved the quality of recycled polypropylene to some degree, there are fundamental limitations of mechanical decontamination approaches, such as the physical entrapment of pigments within a polypropylene matrix. Thus, even with the improvements in mechanical recycling technology, the dark color and high levels of chemical contamination in currently available recycled plastic waste prevents broader usage of recycled resins by the plastics industry.

To overcome the fundamental limitations of mechanical recycling, there have been many methods developed to purify contaminated polypropylene via chemical approaches, or chemical recycling. Most of these methods use solvents to decontaminate and purify polypropylene. The use of solvents enables the extraction of impurities and the dissolution of polypropylene, which further enables alternative separation technologies.

For example, U.S. Pat. No. 7,935,736 describes a method for recycling polyester from polyester-containing waste using a solvent to dissolve the polyester prior to cleaning. The '736 patent also describes the need to use a precipitant to recover the polyester from the solvent.

In another example, U.S. Pat. No. 6,555,588 describes a method to produce a polypropylene blend from a plastic mixture comprised of other polypropylene. The '588 patent describes the extraction of contaminants from a polypropylene at a temperature below the dissolution temperature of the polypropylene in the selected solvent, such as hexane, for a specified residence period. The '588 patent further describes increasing the temperature of the solvent (or a second solvent) to dissolve the polypropylene prior to filtration. The '588 patent yet further describes the use of shearing or flow to precipitate polypropylene from solution. The polypropylene blend described in the '588 patent contained polyethylene contamination up to 5.6 wt %.

In another example, European Patent Application No. 849,312 (translated from German to English) describes a process to obtain purified polyolefins from a polyolefin-containing plastic mixture or a polyolefin-containing waste. The '312 patent application describes the extraction of polyolefin mixtures or wastes with a hydrocarbon fraction of gasoline or diesel fuel with a boiling point above 90° C. at temperatures between 90° C. and the boiling point of the hydrocarbon solvent. The '312 patent application further describes contacting a hot polyolefin solution with bleaching clay and/or activated carbon to remove foreign components from the solution. The '312 patent yet further describes cooling the solution to temperatures below 70° C. to crystallize the polyolefin and then removing adhering solvent by heating the polyolefin above the melting point of the polyolefin, or evaporating the adhering solvent in a vacuum or passing a gas stream through the polyolefin precipitate, and/or extraction of the solvent with alcohol or ketone that boils below the melting point of the polyolefin.

In another example, U.S. Pat. No. 5,198,471 describes a method for separating polypropylene from a physically commingled solid mixture (for example waste plastics) containing a plurality of polypropylene using a solvent at a first lower temperature to form a first single phase solution and a remaining solid component. The '471 patent further describes heating the solvent to higher temperatures to dissolve additional polypropylene that were not solubilized at the first lower temperature. The '471 patent describes filtration of insoluble polypropylene components.

In another example, U.S. Pat. No. 5,233,021 describes a method of extracting pure polymeric components from a multi-component structure (for example waste carpeting) by dissolving each component at an appropriate temperature and pressure in a supercritical fluid and then varying the temperature and/or pressure to extract particular components in sequence. However, similar to the '471 patent, the '021 patent only describes filtration of undissolved components.

In another example, U.S. Pat. No. 5,739,270 describes a method and apparatus for continuously separating a polypropylene component of a plastic from contaminants and other components of the plastic using a co-solvent and a working fluid. The co-solvent at least partially dissolves the polypropylene and the second fluid (that is in a liquid, critical, or supercritical state) solubilizes components from the polypropylene and precipitates some of the dissolved polypropylene from the co-solvent. The '270 patent further describes the step of filtering the thermoplastic-co-solvent (with or without the working fluid) to remove particulate contaminants, such as glass particles.

The known solvent-based methods to purify contaminated polypropylene, as described above, do not produce “virgin-like” polypropylene. In the previous methods, co-dissolution and thus cross contamination of other polypropylene often occurs. If adsorbent is used, a filtration and/or centrifugation step is often employed to remove the used adsorbent from solution. In addition, isolation processes to remove solvent, such as heating, vacuum evaporation, and/or precipitation using a precipitating chemical are used to produce a polypropylene free of residual solvent.

Accordingly, a need still exists for reclaimed polypropylene compositions with “virgin-like” properties that are comparable to virgin polypropylene. The polypropylene compositions produced by the improved solvent-based method disclosed herein are essentially colorless, are essentially odorless, are essentially free of heavy metal contamination, and are essentially free of polymeric contamination.

### SUMMARY OF THE INVENTION

A composition is disclosed that comprises at least about 95 weight percent reclaimed polypropylene. The reclaimed polypropylene comprises less than about 10 ppm Al, less than about 200 ppm Ti, and less than about 5 ppm Zn. The reclaimed polypropylene has a contrast ratio opacity of less than about 15% and the composition is substantially free of odor.

In one embodiment, the reclaimed polypropylene is post consumer recycle derived reclaimed polypropylene. In another embodiment, the reclaimed polypropylene is post-industrial recycle derived reclaimed polypropylene.

In one embodiment, the reclaimed polypropylene comprises less than about 10 ppm Na. In another embodiment, the reclaimed polypropylene comprises less than about 20 ppm Ca.

In one embodiment, the reclaimed polypropylene comprises less than about 2 ppm Cr. In another embodiment, the reclaimed polypropylene comprises less than about 10 ppm Fe.

In one embodiment, the reclaimed polypropylene comprises less than about 20 ppb Ni. In another embodiment, the reclaimed polypropylene comprises less than about 100 ppb Cu.

In one embodiment, the reclaimed polypropylene comprises less than about 10 ppb Cd. In another embodiment, the reclaimed polypropylene comprises less than about 100 ppb Pb.

In one embodiment, the reclaimed polypropylene has a contrast ratio opacity of less than about 10%. In another embodiment, the composition has an odor intensity less than about 2.

Additional features of the invention may become apparent to those skilled in the art from a review of the following detailed description, taken in conjunction with the examples.

### BRIEF DESCRIPTION OF THE DRAWINGS

FIG. 1 is a block flow diagram showing the major steps of one embodiment of the present invention.

FIG. 2 is a calibration curve for the calculation of polyethylene content in polypropylene using enthalpy values from DSC measurements.

FIG. 3 is a schematic of the experimental apparatus used in the examples.

FIG. 4 is a bar chart of the opacity and odor intensity of the examples.

### DETAILED DESCRIPTION OF THE INVENTION

### I. Definitions

As used herein, the term “reclaimed polypropylene” refers to a polypropylene used for a previous purpose and then recovered for further processing.

As used herein, the term “reclaimed polypropylene” refers to polypropylene used for a previous purpose and then recovered for further processing.

As used herein, the term “post-consumer” refers to a source of material that originates after the end consumer has used the material in a consumer good or product.

As used herein, the term “post-consumer recycle” (PCR) refers to a material that is produced after the end consumer has used the material and has disposed of the material in a waste stream.

As used herein, the term “post-industrial” refers to a source of a material that originates during the manufacture of a good or product.

As used herein, the term “fluid solvent” refers to a substance that may exist in the liquid state under specified conditions of temperature and pressure. In some embodiments the fluid solvent may be a predominantly homogenous chemical composition of one molecule or isomer, while in other embodiments, the fluid solvent may be a mixture of several different molecular compositions or isomers. Further, in some embodiments of the present invention, the term “fluid solvent” may also apply to substances that are at, near, or above the critical temperature and critical pressure (critical point) of that substance. It is well known to those having ordinary skill in the art that substances above the critical point of that substance are known as “supercritical fluids” which do not have the typical physical properties (i.e. density) of a liquid.

As used herein, the term “dissolved” means at least partial incorporation of a solute (polymeric or non-polymeric) in a solvent at the molecular level. Further, the thermodynamic stability of the solute/solvent solution can be described by the following equation 1:

ΔGₘᵢₓ=ΔHₘ−TΔSₘᵢₓ (I)

where ΔGₘᵢₓ is the Gibbs free energy change of mixing of a solute with a solvent, ΔHₘᵢₓ is the enthalpy change of mixing, T is the absolute temperature, and ΔSₘᵢₓ is the entropy of mixing. To maintain a stable solution of a solute in a solvent, the Gibbs free energy must be negative and at a minimum. Thus, any combination of solute and solvent that minimize a negative Gibbs free energy at appropriate temperatures and pressures can be used for the present invention.

As used herein, the term “standard boiling point” refers to the boiling temperature at an absolute pressure of exactly 100 kPa (1 bar, 14.5 psia, 0.9869 atm) as established by the International Union of Pure and Applied Chemistry (IUPAC).

As used herein, the term “standard enthalpy change of vaporization” refers to the enthalpy change required to transform a specified quantity of a substance from a liquid into a vapor at the standard boiling point of the substance.

As used herein, the term “substantially free of odor” means odor comparable in both character and intensity to virgin polyethylene as detected by a normally functioning human nose.

As used herein, the term “polypropylene solution” refers to a solution of polypropylene dissolved in a solvent. The polypropylene solution may contain undissolved matter and thus the polypropylene solution may also be a “slurry” of undissolved matter suspended in a solution of polypropylene dissolved in a solvent.

As used herein, the term “solid media” refers to a substance that exists in the solid state under the conditions of use. The solid media may be crystalline, semi-crystalline, or amorphous. The solid media may be granular and may be supplied in different shapes (i.e. spheres, cylinders, pellets, etc.). If the solid media is granular, the particle size and particle size distribution of solid media may be defined by the mesh size used to classify the granular media. An example of standard mesh size designations can be found in the

American Society for Testing and Material (ASTM) standard ASTM El 1 “Standard Specification for Woven Wire Test Sieve Cloth and Test Sieves.” The solid media may also be a non-woven fibrous mat or a woven textile.

As used herein, the term “contrast ratio opacity” refers to the percentage of opaqueness of a 1 mm thick object, as based on the following equation:

Percent Opacity=L* Value of the object measured against a background/L*″ Value of the object measured against a white background)×100

As used herein, the term “purer polypropylene solution” refers to a polypropylene solution having fewer contaminants relative to the same polypropylene solution prior to a purification step.

As used herein, the term “virgin-like” means essentially contaminant-free, pigment-free, odor-free, homogenous, and similar in properties to virgin polypropylene. As used herein, the term “primarily polypropylene copolymer” refers a copolymer with greater than 70 mol % of propylene repeating units.

### II. Compositions Prepared via a Method for Purifying Contaminated Polypropylene

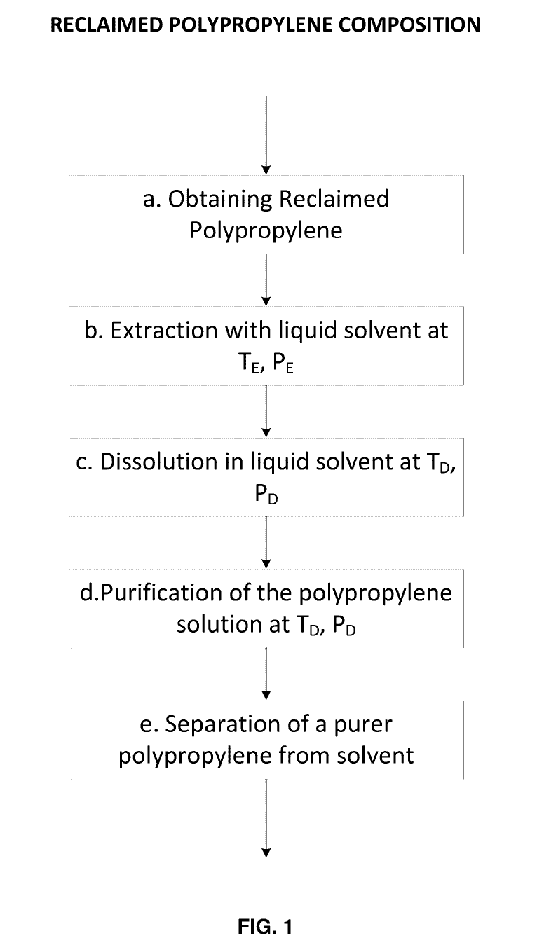

Compositions disclosed herein include reclaimed isotactic polypropylene that has been purified to a virgin-like state in terms of color, odor, opacity, heavy metal contamination, and polymeric contamination. Surprisingly, it has been found that certain fluid solvents, which in a preferred embodiment exhibit temperature and pressure-dependent solubility for polypropylene, when used in a relatively simple process can be used to purify contaminated polypropylene, especially reclaimed or recycled polypropylene, to a near virgin-like quality. This process, exemplified in FIG. 1, comprises 1) obtaining a reclaimed polypropylene (step a in FIG. 1), followed by 2) extracting the polypropylene with a fluid solvent at an extraction temperature (T_{E}) and at an extraction pressure (P_{E}) (step b in FIG. 1), followed by 3) dissolution of the polypropylene in a fluid solvent at a dissolution temperature (T_{D}) and at a dissolution pressure (P_{D}) (step c in FIG. 1), followed by 4) contacting the dissolved polypropylene solution with solid media at a dissolution temperature (T_{D}) and at a dissolution pressure (P_{D}) (step d in FIG. 1), followed by separation of the polypropylene from the fluid solvent (step e in FIG. 1). In one embodiment of the present invention, the purified polypropylene, which may be sourced from post-consumer waste streams, is essentially contaminant-free, pigment-free, odor-free, homogenous, and similar in properties to virgin polypropylene. Furthermore, in a preferred embodiment, the physical properties of the fluid solvent of the present invention may enable more energy efficient methods for separation of the fluid solvent from the purified polypropylene.

### Reclaimed Polypropylene

In one embodiment of the present invention, compositions prepared via a method for purifying reclaimed polypropylene includes obtaining reclaimed polypropylene. For the purposes of the present invention, the reclaimed polypropylene is sourced from post-consumer, post-industrial, post-commercial, and/or other special waste streams. For example, post-consumer waste polypropylene can be derived from curbside recycle streams where end-consumers place used polypropylene from packages and products into a designated bin for collection by a waste hauler or recycler. Post-consumer waste polypropylene can also be derived from in-store “take-back” programs where the consumer brings waste polypropylene into a store and places the waste polypropylene in a designated collection bin. An example of post-industrial waste polypropylene can be waste polypropylene produced during the manufacture or shipment of a good or product that are collected as unusable material by the manufacturer (i.e. trim scraps, out of specification material, start up scrap). An example of waste polypropylene from a special waste stream can be waste polypropylene derived from the recycling of electronic waste, also known as e-waste. Another example of waste polypropylene from a special waste stream can be waste polypropylene derived from the recycling of automobiles. Another example of waste polypropylene from a special waste stream can be waste polypropylene derived from the recycling of used carpeting and textiles.

For the purposes of the present invention, the reclaimed polypropylene is derived from a homogenous stream of reclaimed polypropylene or as part of a mixed stream of several different polypropylene compositions. The reclaimed polypropylene may be a homopolypropylene of propylene monomers or a copolymer with other monomers, such as ethylene, other alpha-olefins, or other monomers that may be apparent to those having ordinary skill in the art. In one embodiment, the reclaimed polypropylene is isotactic polypropylene.

The reclaimed polypropylene may also contain various pigments, dyes, process aides, stabilizing additives, fillers, and other performance additives that were added to the polypropylene during polymerization or conversion of the original polypropylene to the final form of an article. Non-limiting examples of pigments are organic pigments, such as copper phthalocyanine, inorganic pigments, such as titanium dioxide, and other pigments that may be apparent to those having ordinary skill in the art. A non-limiting example of an organic dye is Basic Yellow 51. Non-limiting examples of process aides are antistatic agents, such as glycerol monostearate and slip-promoting agents, such as erucamide. A non-limiting example of a stabilizing additive is octadecyl-3-(3,5-di-tert.butyl-4-hydroxyphenyl)-propionate. Non-limiting examples of fillers are calcium carbonate, talc, and glass fibers.

### Solvent

The fluid solvent used to prepare reclaimed polypropylene compositions of the present invention has a standard boiling point less than about 70° C. Pressurization maintains the solvent, which has a standard boiling point below the operating temperature range of the method to purify reclaimed polypropylene, in a state in which there is little or no solvent vapor. In one embodiment, the fluid solvent with a standard boiling point less than about 70° C. is selected from the group consisting of carbon dioxide, ketones, alcohols, ethers, esters, alkenes, alkanes, and mixtures thereof. Non-limiting examples of fluid solvents with standard boing points less than about 70° C. are carbon dioxide, acetone, methanol, dimethyl ether, diethyl ether, ethyl methyl ether, tetrahydrofuran, methyl acetate, ethylene, propylene, 1-butene, 2-butene, isobutylene, 1-pentene, 2-pentene, branched isomers of pentene, 1-hexene, 2-hexene, methane, ethane, propane, n-butane, isobutane, n-pentane, isopentane, neopentane, n-hexane, isomers of isohexane, and other substances that may be apparent to those having ordinary skill in the art.

The selection of the appropriate solvent or solvent mixture will depend on the source of reclaimed polypropylene as well as the composition of other polypropylene that may be present with the reclaimed polypropylene. Further, the selection of the solvent will dictate the temperature and pressure ranges used to perform the steps of a method to purify reclaimed polypropylene. A review of polypropylene phase behavior in pressurized solvents at various temperatures is provided in the following reference: McHugh et al. (1999) Chem. Rev. 99:565-602.

### Extraction

In one embodiment of the present invention, compositions prepared via a method for purifying reclaimed polypropylene includes contacting a reclaimed polypropylene with a fluid solvent at a temperature and at a pressure wherein the polypropylene is essentially insoluble in the fluid solvent. Although not wishing to be bound by any theory, applicants believe that the temperature and pressure-dependent solubility can be controlled in such a way to prevent the fluid solvent from fully solubilizing the polypropylene, however, the fluid solvent can diffuse into the polypropylene and extract any extractable contamination. The extractable contamination may be residual processing aides added to the polypropylene, residual product formulations which contacted the polypropylene, such as perfumes and flavors, dyes, and any other extractable material that may have been intentionally added or unintentionally became incorporated into the polypropylene, for example, during waste collection and subsequent accumulation with other waste materials.

In one embodiment, the controlled extraction may be accomplished by fixing the temperature of the polypropylene/fluid solvent system and then controlling the pressure below a pressure, or pressure range, where the polypropylene dissolves in the fluid solvent. In another embodiment, the controlled extraction is accomplished by fixing the pressure of the polypropylene/solvent system and then controlling the temperature below a temperature, or temperature range where the polypropylene dissolves in the fluid solvent. The temperature and pressure-controlled extraction of the polypropylene with a fluid solvent uses a suitable pressure vessel and may be configured in a way that allows for continuous extraction of the polypropylene with the fluid solvent. In one embodiment, the pressure vessel may be a continuous liquid-liquid extraction column where molten polypropylene is pumped into one end of the extraction column and the fluid solvent is pumped into the same or the opposite end of the extraction column. In another embodiment, the fluid containing extracted contamination is removed from the process. In another embodiment, the fluid containing extracted contamination is purified, recovered, and recycled for use in the extraction step or a different step in the process. In one embodiment, the extraction may be performed as a batch method, wherein the reclaimed polypropylene is fixed in a pressure vessel and the fluid solvent is continuously pumped through the fixed polypropylene phase. The extraction time or the amount of fluid solvent used will depend on the desired purity of the final purer polypropylene and the amount of extractable contamination in the starting reclaimed polypropylene. In another embodiment, the fluid containing extracted contamination is contacted with solid media in a separate step as described in the “Purification” section below. In another embodiment, compositions prepared via a method for purifying reclaimed polypropylene includes contacting a reclaimed polypropylene with a fluid solvent at a temperature and at a pressure wherein the polypropylene is molten and in the liquid state. In another embodiment, the reclaimed polypropylene is contacted with the fluid solvent at a temperature and at a pressure wherein the polypropylene is in the solid state.

In one embodiment, compositions prepared via a method for purifying reclaimed polypropylene includes contacting polypropylene with a fluid solvent at a temperature and a pressure wherein the polypropylene remains essentially undissolved. In another embodiment, compositions are prepared by contacting polypropylene with n-butane at a temperature from about 80° C. to about 220° C. In another embodiment, compositions are prepared by contacting polypropylene with n-butane at a temperature from about 100° C. to about 200° C. In another embodiment, compositions are prepared by contacting polypropylene with n-butane at a temperature from about 130° C. to about 180° C. In another embodiment, compositions are prepared by contacting polypropylene with n-butane at a pressure from about 150 psig (1.03 MPa) to about 3,000 psig (20.68 MPa). In another embodiment, compositions are prepared by contacting polypropylene with n-butane at a pressure from about 1,000 psig (6.89 MPa) to about 2,750 psig (18.96 MPa). In another embodiment, compositions are prepared by contacting polypropylene with n-butane at a pressure from about 1,500 psig (10.34 MPa) to about 2,500 psig (17.24 MPa).

In another embodiment, compositions are prepared by contacting polypropylene with propane at a temperature from about 80° C. to about 220° C. In another embodiment, compositions are prepared by contacting polypropylene with propane at a temperature from about 100° C. to about 200° C. In another embodiment, compositions are prepared by contacting polypropylene with propane at a temperature from about 130° C. to about 180° C. In another embodiment, compositions are prepared by contacting polypropylene with propane at a pressure from about 200 psig (1.38 MPa) to about 8,000 psig (55.16 MPa). In another embodiment, compositions are prepared by contacting polypropylene with propane at a pressure from about 1,000 psig (6.89 MPa) to about 6,000 psig (41.37 MPa). In another embodiment, compositions are prepared by contacting polypropylene with propane at a pressure from about 2,000 psig (13.79 MPa) to about 4,000 psig (27.58 MPa).

### Dissolution

In one embodiment of the present invention, compositions are prepared by dissolving the reclaimed polypropylene in a fluid solvent at a temperature and at a pressure wherein the polypropylene is dissolved in the fluid solvent. Although not wishing to be bound by any theory, applicants believe that the temperature and pressure can be controlled in such a way to enable thermodynamically favorable dissolution of the reclaimed polypropylene in a fluid solvent. Furthermore, the temperature and pressure can be controlled in such a way to enable dissolution of a particular polypropylene or polypropylene mixture while not dissolving other polypropylene or polypropylene mixtures. This controllable dissolution enables the separation of polypropylene from polymer mixtures.

In one embodiment of the present invention, compositions are prepared by dissolving contaminated reclaimed polypropylene in a solvent that does not dissolve the contaminants under the same conditions of temperature and pressure. The contaminants may include pigments, fillers, dirt, and other polymers. These contaminants are released from the reclaimed polypropylene upon dissolution and then removed from the polypropylene solution via a subsequent solid-liquid separation step.

In one embodiment, compositions are prepared by dissolving polypropylene in a fluid solvent at a temperature and a pressure wherein the polypropylene is dissolved in the fluid solvent. In another embodiment, compositions are prepared by dissolving polypropylene in n-butane at a temperature from about 90° C. to about 220° C. In another embodiment, compositions are prepared by dissolving polypropylene in n-butane at a temperature from about 100° C. to about 200° C. In another embodiment, compositions are prepared by dissolving polypropylene in n-butane at a temperature from about 130° C. to about 180° C. In another embodiment, compositions are prepared by dissolving polypropylene in n-butane at a pressure from about 350 psig (2.41 MPa) to about 4,000 psig (27.58 MPa). In another embodiment, compositions are prepared by dissolving polypropylene in n-butane at a pressure from about 1,000 psig (6.89 MPa) to about 3,500 psig (24.13 MPa). In another embodiment, compositions are prepared by dissolving polypropylene in n-butane at a pressure from about 2,000 psig (13.79 MPa) to about 3,000 psig (20.68 MPa).

In another embodiment, compositions are prepared by dissolving polypropylene in propane at a temperature from about 90° C. to about 220° C. In another embodiment, compositions are prepared by dissolving polypropylene in propane at a temperature from about 100° C. to about 200° C. In another embodiment, compositions are prepared by dissolving polypropylene in propane at a temperature from about 130° C. to about 180° C. In another embodiment, compositions are prepared by dissolving polypropylene in propane at a pressure from about 2,000 psig (13.79 MPa) to about 8,000 psig (55.16 MPa). In another embodiment, compositions are prepared by dissolving polypropylene in propane at a pressure from about 3,000 psig (20.68 MPa) to about 6,000 psig (41.37 MPa). In another embodiment, compositions are prepared by dissolving polypropylene in propane at a pressure from about 3,500 psig (24.13 MPa) to about 5,000 psig (34.47 MPa).

### Purification

In one embodiment of the present invention, compositions are prepared by contacting a contaminated polypropylene solution with solid media at a temperature and at a pressure wherein the polypropylene remains dissolved in the fluid solvent. The solid media used to prepare compositions of the present invention is any solid material that removes at least some of the contamination from a solution of reclaimed polypropylene dissolved in a fluid solvent. Although not wishing to be bound by any theory, the applicants believe that solid media removes contamination by a variety of mechanisms. Non-limiting examples of possible mechanisms includes: adsorption, absorption, size exclusion, ion exclusion, ion exchange, and other mechanisms that may be apparent to those having ordinary skill in the art. Furthermore, the pigments and other contaminants commonly found in reclaimed polypropylene may be polar compounds and may preferentially interact with the solid media, which may also be at least slightly polar. The polar-polar interactions are especially favorable when non-polar solvents, such as alkanes, are used as the fluid solvent.

In one embodiment, the solid media used to prepare compositions of the present invention is selected from the group consisting of inorganic substances, carbon-based substances, or mixtures thereof. Useful examples of inorganic substances include oxides of silica, oxides of aluminum, oxides of iron, aluminum silicates, magnesium silicates, amorphous volcanic glasses, silica, silica gel, diatomite, sand, quartz, reclaimed glass, alumina, perlite, fuller's earth, bentonite, and mixtures thereof. Useful examples of carbon-based substances include anthracite coal, carbon black, coke, activated carbon, cellulose, and mixtures thereof. In another embodiment, the solid media is recycled glass.

In one embodiment, the solid media is contacted with the polypropylene in a vessel for a specified amount of time while the solid media is agitated. In another embodiment, the solid media is removed from the purer polypropylene solution via a solid-liquid separation step. Non-limiting examples of solid-liquid separation steps include filtration, decantation, centrifugation, and settling. In another embodiment, the contaminated polypropylene solution is passed through a stationary bed of solid media. In another embodiment, the height or length of the stationary bed of solid media used to prepare compositions of the present invention is greater than 5 cm. In another embodiment, the height or length of the stationary bed of solid media is greater than 10 cm. In another embodiment, the height or length of the stationary bed of solid media is greater than 20 cm. In another embodiment, the solid media is replaced as needed to maintain a desired purity of polypropylene. In yet another embodiment, the solid media is regenerated and re-used in the purification step. In another embodiment, the solid media is regenerated by fluidizing the solid media during a backwashing step.

In one embodiment, compositions are prepared by contacting a polypropylene/fluid solvent solution with solid media at a temperature and at a pressure wherein the polypropylene remains dissolved in the fluid solvent. In another embodiment, compositions are prepared by contacting a polypropylene/n-butane solution with solid media at a temperature from about 90° C. to about 220° C. In another embodiment, compositions are prepared by contacting a polypropylene/n-butane solution with solid media at a temperature from about 100° C. to about 200° C. In another embodiment, compositions are prepared by contacting a polypropylene/n-butane solution with solid media at a temperature from about 130° C. to about 180° C. In another embodiment, compositions are prepared by contacting a polypropylene/n-butane solution with solid media at a pressure from about 350 psig (2.41 MPa) to about 4,000 psig (27.58 MPa). In another embodiment, compositions are prepared by contacting a polypropylene/n-butane solution with solid media at a pressure from about 1,000 psig (6.89 MPa) to about 3,500 psig (24.13 MPa). In another embodiment, compositions are prepared by contacting a polypropylene/n-butane solution with solid media at a pressure from about 2,000 psig (13.79 MPa) to about 3,000 psig (20.68 MPa).

In another embodiment, compositions are prepared by contacting a polypropylene/propane solution with solid media at a temperature from about 90° C. to about 220° C. In another embodiment, compositions are prepared by contacting a polypropylene/propane solution with solid media at a temperature from about 100° C. to about 200° C. In another embodiment, compositions are prepared by contacting a polypropylene/propane solution with solid media at a temperature from about 130° C. to about 180° C. In another embodiment, compositions are prepared by contacting a polypropylene/propane solution with solid media at a pressure from about 2,000 psig (13.79 MPa) to about 8,000 psig (55.16 MPa). In another embodiment, compositions are prepared contacting a polypropylene/propane solution with solid media at a pressure from about 3,000 psig (20.68 MPa) to about 6,000 psig (41.37 MPa). In another embodiment, compositions are prepared by contacting a polypropylene/propane solution with solid media at a pressure from about 3,500 psig (24.13 MPa) to about 5,000 psig (34.47 MPa).

### Separation

In one embodiment of the present invention, compositions are prepared by separating the purer polypropylene from the fluid solvent at a temperature and at a pressure wherein the polypropylene precipitates from solution and is no longer dissolved in the fluid solvent. In another embodiment, the precipitation of the purer polypropylene from the fluid solvent is accomplished by reducing the pressure at a fixed temperature. In another embodiment, the precipitation of the purer polypropylene from the fluid solvent is accomplished by reducing the temperature at a fixed pressure. In another embodiment, the precipitation of the purer polypropylene from the fluid solvent is accomplished by increasing the temperature at a fixed pressure. In another embodiment, the precipitation of the purer polypropylene from the fluid solvent is accomplished by reducing both the temperature and pressure. The solvent can be partially or completely converted from the liquid to the vapor phase by controlling the temperature and pressure. In another embodiment, the precipitated polypropylene is separated from the fluid solvent without completely converting the fluid solvent into a 100% vapor phase by controlling the temperature and pressure of the solvent during the separation step. The separation of the precipitated purer polypropylene is accomplished by any method of liquid-liquid or liquid-solid separation. Non-limiting examples of liquid-liquid or liquid-solid separations include filtration, decantation, centrifugation, and settling.

In one embodiment, compositions are prepared by separating polypropylene from a polypropylene/fluid solvent solution at a temperature and at a pressure wherein the polypropylene precipitates from solution. In another embodiment, compositions are prepared by separating polypropylene from a polypropylene/n-butane solution at a temperature from about 0° C. to about 220° C. In another embodiment, compositions are prepared by separating polypropylene from a polypropylene/n-butane solution at a temperature from about 100° C. to about 200° C. In another embodiment, compositions are prepared by separating polypropylene from a polypropylene/n-butane solution at a temperature from about 130° C. to about 180° C. In another embodiment, compositions are prepared by separating polypropylene from a polypropylene/n-butane solution at a pressure from about 0 psig (0 MPa) to about 2,000 psig (13.79 MPa). In another embodiment, compositions are prepared by separating polypropylene from a polypropylene/n-butane solution at a pressure from about 50 psig (0.34 MPa) to about 1,500 psig (10.34 MPa). In another embodiment, compositions are prepared by separating polypropylene from a polypropylene/n-butane solution at a pressure from about 75 psig (0.52 MPa) to about 1,000 psig (6.89 MPa).

In another embodiment, compositions are prepared by separating polypropylene from a polypropylene/propane solution at a temperature from about −42° C. to about 220° C. In another embodiment, compositions are prepared by separating polypropylene from a polypropylene/propane solution at a temperature from about 0° C. to about 150° C. In another embodiment, compositions are prepared by separating polypropylene from a polypropylene/propane solution at a temperature from about 50° C. to about 130° C. In another embodiment, compositions are prepared by separating polypropylene from a polypropylene/propane solution at a pressure from about 0 psig (0 MPa) to about 6,000 psig (41.37 MPa). In another embodiment, compositions are prepared by separating polypropylene from a polypropylene/propane solution at a pressure from about 50 psig (0.34 MPa) to about 3,000 psig (20.68 MPa). In another embodiment, compositions are prepared by separating polypropylene from a polypropylene/propane solution at a pressure from about 75 psig (0.52 MPa) to about 1,000 psig (6.89 MPa).

### III Test Methods

The test methods described herein are used to measure the properties of reclaimed polypropylene compositions. Specifically, the test methods described measure the color and translucency/clarity (i.e. making the color and opacity of the reclaimed polypropylene closer to that of an uncolored virgin polypropylene), the amount of elemental contamination (i.e. heavy metals), the amount of non-combustible contamination (i.e. inorganic fillers), the amount of volatile compounds that contribute to the malodor of reclaimed polypropylene, and the amount of polymeric contamination (i.e. polyethylene contamination in reclaimed polypropylene).

### Color and Opacity Measurement:

The color and opacity/translucency of a polymer are important parameters that determine whether or not a polymer can achieve the desired visual aesthetics of an article manufactured from the polymer. Reclaimed polymers, especially post-consumer derived reclaimed polymers, are typically dark in color and opaque due to residual pigments, fillers, and other contamination. Thus, improving the color and opacity profile of a reclaimed polymer is an important factor for broadening the potential end uses of the reclaimed polypropylene compositions of the present invention versus known reclaimed polypropylene compositions.

Prior to color measurement, samples of either polymeric powders or pellets were compression molded into 30 mm wide×30 mm long×1 mm thick square test specimens (with rounded corners). Powder samples were first densified at room temperature (ca. 20-23° C.) by cold pressing the powder into a sheet using clean, un-used aluminum foil as a contact-release layer between stainless steel platens. Approximately 0.85 g of either cold-pressed powder or pellets was then pressed into test specimens on a Carver Press Model C (Carver, Inc., Wabash, Ind. 46992-0554 USA) pre-heated to 200° C. using aluminum platens, unused aluminum foil release layers, and a stainless steel shim with a cavity corresponding to aforementioned dimensions of the square test specimens. Samples were heated for 5 minutes prior to applying pressure. After 5 minutes, the press was then compressed with at least 2 tons (1.81 metric tons) of hydraulic pressure for at least 5 seconds and then released. The molding stack was then removed and placed between two thick flat metal heat sinks for cooling. The aluminum foil contact release layers were then peeled from the sample and discarded. The flash around the sample on at least one side was peeled to the mold edge and then the sample was pushed through the form. Each test specimen was visually evaluated for voids/bubble defects and only samples with no defects in the color measurement area (0.7″ (17.78 mm) diameter minimum) were used for color measurement.

The color of each sample was characterized using the International Commission on Illumination (CIE) L*, a*, b* three dimensional color space. The dimension L* is a measure of the lightness of a sample, with L*=0 corresponding to the darkest black sample and L*=100 corresponding to the brightest white sample. The dimension a* is a measure of the red or green color of a sample with positive values of a* corresponding with a red color and negative values of a* corresponding with a green color. The dimension b* is a measure of the blue or yellow color of a sample with positive values of b* corresponding with a blue color and negative values of b* corresponding with a yellow color. The L*a*b* values of each 30 mm wide×30 mm long×1 mm thick square test specimen sample were measured on a HunterLab model LabScan XE spectrophotometer (Hunter Associates Laboratory, Inc., Reston, Va. 20190-5280, USA). The spectrophotometer was configured with D65 as the standard illuminant, an observer angle of 10°, an area diameter view of 1.75″ (44.45 mm), and a port diameter of 0.7″ (17.78 mm).

The opacity of each sample, which is a measure of how much light passes through the sample (i.e. a measure of the sample's translucency), was determined using the aforementioned HunterLab spectrophotometer using the contrast ratio opacity mode. Two measurements were made to determine the opacity of each sample. One to measure the brightness value of the sample backed with a white backing, Y_{WhiteBacking}, and one to measure the brightness value of the sample backed with a black backing, Y_{BlackBacking}. The opacity was then calculated from the brightness values using the following equation 2:

$$\% Opacity = \frac{{Y}_{Black Backing}}{{Y}_{White Backing}} * 100 \qquad ( II )$$

### Elemental Analysis:

Reclaimed polymers, including reclaimed polypropylene, often have unacceptably high concentrations of heavy metal contamination. The presence of heavy metals, for example lead, mercury, cadmium, and chromium, may prevent the use of reclaimed polypropylene in certain applications, such as food or drug contact applications or medical device applications. Thus, reducing the concentration of heavy metals is an important factor for broadening the potential end uses of reclaimed polypropylene compositions of the present invention versus known polypropylene compositions.

Elemental analysis was performed using Inductively Coupled Plasma Mass Spectrometry (ICP-MS). Test solutions were prepared in n=2 to n=6 depending on sample availability by combing ˜0.25 g sample with 4 mL of concentrated nitric acid and 1 mL of concentrated hydrofluoric acid (HF). The samples were digested using an Ultrawave Microwave Digestion protocol consisting of a 20 min ramp to 125° C., a 10 min ramp to 250° C. and a 20 min hold at 250° C. Digested samples were cooled to room temperature. The digested samples were diluted to 50 mL after adding 0.25 mL of 100 ppm Ge and Rh as the internal standard. In order to assess accuracy of measurement, pre-digestion spikes were prepared by spiking virgin polymer. Virgin polymer spiked samples were weighed out using the same procedure mentioned above and spiked with the appropriate amount of each single element standard of interest, which included the following: Na, Al, Ca, Ti, Cr, Fe, Ni, Cu, Zn, Cd, and Pb. Spikes were prepared at two different levels: a “low level spike” and a “high level spike”. Each spike was prepared in triplicate. In addition to spiking virgin polymer, a blank was also spiked to verify that no errors occurred during pipetting and to track recovery through the process. The blank spiked samples were also prepared in triplicate at the two different levels and were treated in the same way as the spiked virgin polymer and the test samples. A 9 point calibration curve was made by making 0.05, 0.1, 0.5, 1, 5, 10, 50, 100, and 500 ppb solutions containing Na, Al, Ca, Ti, Cr, Fe, Ni, Cu, Zn, Cd, and Pb. All calibration standards were prepared by dilution of neat standard reference solutions and 0.25 mL of 100 ppm Ge and Rh as the internal standard with 4 mL of concentrated nitric and 1 mL of concentrated HF. Prepared standards, test samples, and spiked test samples were analyzed using an Agilent's 8800 ICP-QQQMS, optimized according to manufacturer recommendations. The monitored m/z for each analyte and the collision cell gas that was used for analysis was as follows: Na, 23 m/z, H₂; Al, 27 m/z, H₂; Ca, 40 m/z, H₂; Ti, 48 m/z, H₂; Cr, 52 m/z, He; Fe, 56 m/z, H₂; Ni, 60 m/z; no gas; Cu, 65 m/z, no gas; Zn, 64 m/z, He; Cd, 112 m/z; H₂; Pb, sum of 206≧206, 207≧2 07, 208≧208 m/z, no gas; Ge, 72 m/z, all modes; Rh, 103 m/z, all modes. Ge was used as an internal standard for all elements <103 m/z and Rh was used for all elements >103 m/z.

### Residual Ash Content:

Reclaimed polymers, including reclaimed polypropylene, contain various fillers, for example calcium carbonate, talcum, and glass fiber. While useful in the original application of the reclaimed polypropylene, these fillers alter the physical properties of a polypropylene in way that may be undesired for the next application of the reclaimed polypropylene. Thus, reducing the the amount of filler is an important factor for broadening the potential end uses of the reclaimed polypropylene compositions of the present invention versus known polypropylene compositions.

Thermogravimetric analysis (TGA) was performed to quantify the amount of non-combustible materials in the sample (also sometimes referred to as Ash Content). About 5-15 mg of sample was loaded onto a platinum sample pan and heated to 700° C. at a rate of 20° C./min in an air atmosphere in a TA Instruments model Q500 TGA instrument.

The sample was held isothermal for 10 min at 700° C. The percentage residual mass was measured at 700° C. after the isothermal hold.

### Odor Analysis:

Odor sensory analysis was performed by placing about 3 g of each sample in a 20 mL glass vial and equilibrating the sample at room temperature for at least 30 min. After equilibration, each vial was opened and the headspace was sniffed (bunny sniff) by a trained grader to determine odor intensity and descriptor profile. Odor intensity was graded according to the following scale:

5=Very Strong

4=Strong

3=Moderate

2=Weak to Moderate

1=Weak

0=No odor

### Polypropylene Contamination Analysis:

Reclaimed polypropylene, especially reclaimed polypropylene originating from mixed-stream sources, may contain undesired polymeric contamination. Without wishing to be bound by any theory, polymeric contamination, for example polyethylene contamination in polypropylene, may influence the physical properties of the polypropylene due to the presence of heterogeneous phases and the resulting weak interfaces. Furthermore, the polymeric contamination may also increase the opacity of the polypropylene and have an influence on the color. Thus, measuring the amount of polymeric contamination can be an important factor when distinguishing reclaimed polypropylene compositions of the present invention from known polypropylene compositions.

Semi-crystalline polymeric contamination was evaluated using Differential Scanning Calorimetry (DSC). To measure the amount of polyethylene contamination in polypropylene, a set of five polypropylene/polyethylene blends were prepared with 2, 4, 6, 8, 10 wt % of Formolene® HB5502F HDPE (Formosa Plastics Corporation, USA) in Pro-fax 6331 polypropylene (LyondellBasell Industries Holdings, B.V.). Approximately 5-15 mg of each sample was sealed in an aluminum DSC pan and analyzed on a TA Instruments model Q2000 DSC with the following method:

1. Equilibrate at 30.00° C.

2. Ramp 20.00° C./min to 200.00° C.

3. Mark end of cycle 0

4. Ramp 20.00° C./min to 30.00° C.

5. Mark end of cycle 1

6. Ramp 20.00° C./min to 200.00° C.

7. Mark end of cycle 2

8. Ramp 20.00° C./min to 30.00° C.

9. Mark end of cycle 3

10. Ramp 5.00° C./min to 200.00° C.

11. Mark end of cycle 4

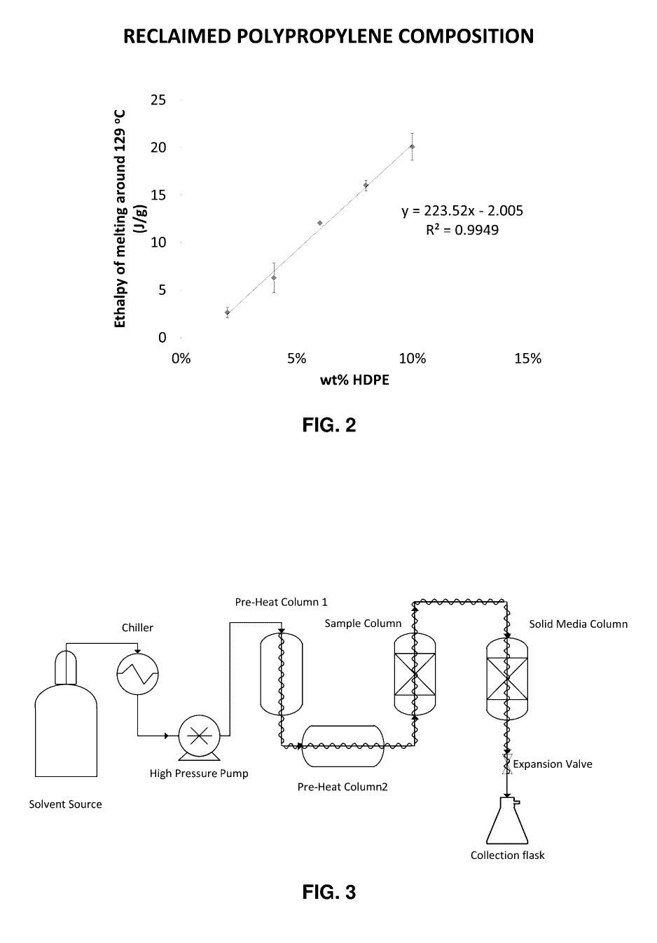

The enthalpy of melting for the HDPE peak around 128° C. was calculated for each sample of known HDPE content using the 5.00° C./min DSC thermogram. A linear calibration curve, shown in FIG. 2, was established plotting enthalpy of melting versus known HDPE concentration (wt %).

Samples having unknown PE content were analyzed using the same aforementioned DSC equipment and method. PE content was calculated using the aforementioned calibration curve. The specific HDPE used to generate the calibration curve will more than likely have a different degree of crystallinity than the polyethylene (or polyethylene blend) contamination that may be present in a reclaimed polypropylene sample. The degree of crystallinity may independently influence the measured enthalpy of melting for polyethylene and thus influence the resulting calculation of polyethylene content. However, the DSC test method described herein is meant to serve as a relative metric to compare compositions and is not meant to be a rigorous quantification of the polyethylene content in a polypropylene blend. While the aforementioned method described the measurement of polyethylene contamination in polypropylene, this method may be applied to measurement of other semi-crystalline polymers using different temperature ranges and peaks in the DSC thermogram. Furthermore, alternative methods, such as nuclear magnetic resonance (NMR) spectroscopy, may also be used to measure the amount of both semi-crystalline and amorphous polymeric contamination in a sample.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention.

### Example 1

A sample of post-consumer derived recycled polypropylene mixed color flake was sourced from a supplier of recycled resins. The post-consumer recycled polypropylene originated from the United States and Canada. The as-received mixed color flake was homogenized via compounding on a Century/W&P ZSK30 twin screw extruder equipped with two 30 mm general purpose screws each with standard mixing and conveying elements. The screw rotation speed was about 50 rpm, the feeder throughput was about 20 lbs/hour (9.07 kg/hr) and the temperature of the barrel ranged from about 210° C. at the die to about 150° C. at the feed throat. The gray strand exiting the extruder was cooled in room-temperature water bath, dried with air, and chopped into pellets.

The sample was characterized using the test methods disclosed herein and the resulting data are summarized in Table 1. The purpose of this example is to show the properties of a representative composition of post-consumer derived recycled resin.

The pellets and corresponding square test specimens were dark gray in color as indicated in the L*a*b* values of the square test specimens. The opacity of the samples averaged about 100% opaque (i.e. no translucency).

This example serves as a representative baseline for elemental contamination found in post-consumer derived recycled polypropylene. When compared to other examples, the heavy metal contamination was found to be much greater in the as-received post-consumer derived recycled polypropylene. The concentration of aluminum in the samples of example 1 averaged to 192,000 ppb (192 ppm). The concentration of titanium averaged to 2,800,000 ppb (2,800 ppm). The concentration of zinc averaged to 71,000 ppb (71.0 ppm). The concentration of sodium averaged to 136,000 ppb (136 ppm). The concentration of calcium averaged to 1,590,000 ppb (1,590 ppm). The concentration of chromium averaged to 4,710 ppb (4.71 ppm). The concentration of iron averaged to 108,000 ppb (108 ppm). The concentration of nickel averaged to 1,160 ppb (1.16 ppm). The concentration of copper averaged to 15,300 ppb (15.3 ppm). The concentration of cadmium averaged to 1,620 ppb (1.62 ppm). The concentration of lead averaged to 12,200 ppb (12.2 ppm).

The samples of example 1 had ash content values that averaged to about 1.2117 wt %, which also serves as a baseline for the amount of non-combustible substances that are often present in post-consumer derived recycled polypropylene.

This example also serves as a representative baseline for odor compound contamination found in post-consumer derived recycled polypropylene. The samples of example 1 were found to have an odor intensity of 3.75 on a 5 point scale (5 being most intense), and were described as having a “garbage”, “dusty”, or “sour” odor.

This example also serves as a representative baseline for polyethylene contamination found in post-consumer derived recycled polypropylene. The samples of example 1 had polyethylene contents that averaged to about 5.5 wt %.

### Example 2

The sample of post-consumer derived recycled polypropylene mixed color flake described in Example 1 was processed using the experimental apparatus shown in FIG. 3 and the following:
1. 237 g of the mixed color flake was loaded into a 1.1 L extraction column pressure vessel with an internal diameter (ID) of 1.75″ (4.45 cm) and a length of 28″ (71.12 cm) that was heated to an external skin temperature of 175° C.
2. Liquid n-butane solvent was pressurized to about 2,150 psig (14.82 MPa) using a positive displacement pump and pre-heated to a temperature of about 110° C. using two heat exchangers before it was introduced to the bottom of the extraction column.
3. The fluid stream leaving the top of the extraction column was introduced into the top of a second 0.5 L pressure vessel with an ID of 2″ (5.08 cm) and a length of about 8.5″ (21.59 cm) that was heated to an external skin temperature of 175° C. The second pressure vessel contained 150 mL of silica gel (Silicycle Ultra Pure Silica Gels, SiliaFlash GE60, Parc-Technologies, USA) that was pre-mixed in a beaker with 150 mL of aluminum oxide (Activated Alumina, Selexsorb CDX, 7×14, BASF, USA).
4. The fluid stream leaving the bottom of the second pressure vessel was depressurized across an expansion valve into a side-arm Erlenmeyer flask. After depressurizing the fluid stream into the Erlenmeyer flask, the solvent vapor was vented through the side-arm port and any liquids/solids were collected in the flask. The n-butane solvent was eluted through the system at 2,150 psig (14.82 MPa) until no further material was observed accumulating in the flask. 19.93 g of white solids were collected and labeled ‘Fraction 1’.
5. The Erlenmeyer flask was replaced with an empty, clean flask and the system pressure was then increased to 2,400 psig (16.55 MPa).
6. The system pressure was maintained at 2,400 psig (16.55 MPa) until no further solid material was observed eluting from the system. 89.35 g of white solids were collected and labeled ‘Fraction 2’.
7. The Erlenmeyer flask was replaced with an empty, clean flask and the system pressure was then increased to 2,500 psig (17.24 MPa).
8. The system pressure was maintained at 2,500 psig (17.24 MPa) until no further solid material was observed eluting from the system. 58.18 g of white solids were collected and labeled ‘Fraction 3’.
9. The Erlenmeyer flask was replaced with an empty, clean flask and the system pressure was then increased to 2,600 psig (17.93 MPa).
10. The system pressure was maintained at 2,600 psig (17.93 MPa) until no further solid material was observed eluting from the system. 7.29 g of white solids were collected and labeled ‘Fraction 4’.
11. The Erlenmeyer flask was replaced with an empty, clean flask and the system pressure was then increased to 3,000 psig (20.68 MPa).
12. The system pressure was maintained at 3,000 psig (20.68 MPa) until no further solid material was observed eluting from the system. 5.58 g of off-white solids were collected and labeled ‘Fraction 5’.
13. The samples collected in each flask were allowed to degas at room temperature and pressure for at least two days before being characterized using the test methods disclosed herein.

The data for the white solid material collected at 2,400 psig (16.55 MPa) as Fraction 2 are summarized in Table 1. This example demonstrates one embodiment of a composition of the present invention.

The solids isolated in fractions 1-5 in this example were white in color. When the white solids from fraction 2 were compression molded into square test specimens, the specimens were colorless and clear and similar in appearance to virgin polypropylene.

The L*a*b* values showed that the square test specimens were essentially colorless and showed a dramatic improvement in color relative to the square test specimens of example 1 (i.e. as-received post-consumer derived polypropylene). The L* values for the square test specimens from fraction 2 of example 2 averaged 85.29 which were much improved when compared to the L* values for the square test specimens of example 1, which averaged 39.76. The opacity for the square test specimens from fraction 2 of example 2, which averaged 7.90% opaque (i.e. about 92% translucent), were also much improved when compared to the opacity values for the square test specimens of example 1, which averaged about 100% opaque.

The concentration of heavy metal contamination for the samples from fraction 2 of example 2 were much improved and significantly lower when compared to the samples of example 1. The concentration of aluminum was below the limit of quantitation. The concentration of titanium averaged to 638 ppb (0.638 ppm). The concentration of zinc averaged to 261 ppb (0.261 ppm). The concentration of sodium averaged to 2,630 ppb (2.63 ppm). The concentration of calcium averaged to 2,680 ppb (2.68 ppm). The concentration of chromium averaged to 17.5ppb (0.0175 ppm). The concentration of iron was below the limit of quantitation. The concentration of nickel averaged to 10.9 ppb (0.0109 ppm). The concentration of copper averaged to 33.0 ppb (0.0330 ppm). The concentration of cadmium was below the limit of quantitation. The concentration of lead was below the limit of quantitation.

The samples from fraction 2 of example 2 had ash content values that averaged to about 0.2897 wt %, which were significantly lower than the ash content values for the samples of example 1, which averaged to about 1.2117 wt %.

The samples from fraction 2 of example 2 were found to have an odor intensity of 0.5 on a 5 point scale (5 being most intense), which was much improved when compared to the odor intensity of the samples of example 1, which had an odor intensity of 3.75. Though low in odor intensity, the samples from fraction 2 of example 2 were described as having a “plastic” or “gasoline” like odor similar to virgin polypropylene.

Any polyethylene content in the samples from fraction 2 of example 2 was below the limit of quantitation, which was much improved when compared to the polyethylene content of the samples of example 1, which averaged to about 5.5 wt %.

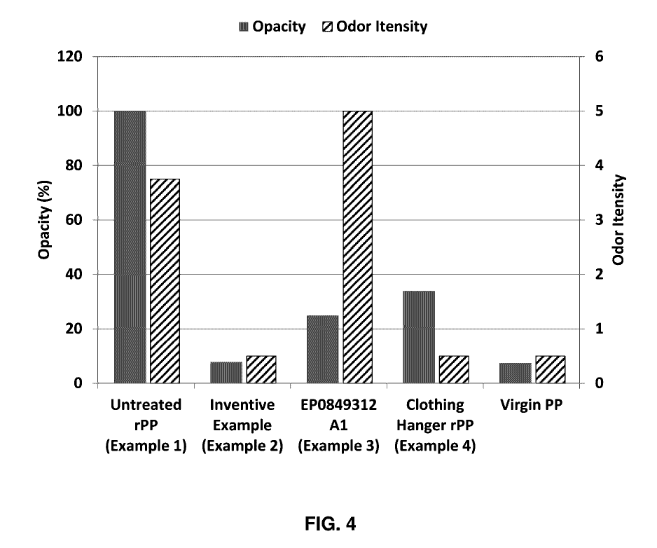

FIG. 4 is a bar chart of the opacity and odor intensity of the purified recycled polypropylene of example 2 compared to the untreated recycled polypropylene (example 1), the recycled polypropylene treated according to method disclosed in EP0849312 A1 (example 3), a sample of recycled polypropylene from clothing hangers (example 4), and a virgin polypropylene comparative sample. As shown in FIG. 4, the purified recycled polypropylene of example 2 had both a low opacity and a low odor intensity and was similar to the virgin polypropylene comparative sample.

### Example 3

The sample of post-consumer derived recycled polypropylene mixed color flake described in Example 1 was purified using a procedure based on the procedure described in EP0849312 A1.

20.00 g of post-consumer derived recycled polypropylene mixed color flake was combined with 400.04 g of white spirits (Sigma-Aldrich, USA) in a 1 L round-bottomed flask. The mixture was held at room temperature for 22 hours with occasional stirring. The white spirits was then decanted from the polypropylene. 402.60 g of fresh white spirits was added to the flask containing the polypropylene. The mixture was then heated and held at 140° C. for 90 min under reflux. The resulting hot solution was vacuum filtered through a 70 mm ID Buchner funnel with a layer of glass wool as the filtration medium. About 300 mL of filtrate was collected and allowed to cool to room temperature. The resulting gray precipitate was isolated via vacuum filtration through a 70 mm ID Buckner funnel with shark skin filter paper. The gray precipitate was combined with 2.01 g of Fuller's earth (Sigma-Aldrich, USA) and 195.21 g of fresh white spirits in a 1 L round-bottomed flask and then heated and held at 140° C. for 30 min under reflux. The resulting hot solution was vacuum filtered through a 5.5 cm ID Buchner funnel with shark skin filter paper. The filtrate was allowed to cool to room temperature. The resulting light gray precipitate was isolated via vacuum filtration through a 5.5 cm ID Buchner funnel with shark skin filter paper. The isolated precipitate was dried in a vacuum oven at 25° C. for about 18 hours. About 4.82 g of dried precipitate was isolated. The isolated precipitate was then extracted with acetone for 30 min using a Soxhlet extraction apparatus equipped with a cellulose extraction thimble. The extracted material was dried in a vacuum oven at 25° C. for about 19 hours. 3.4654 g of material was recovered. The resulting sample composition was characterized using the test methods disclosed herein and the resulting data are summarized in Table 1.

The solids isolated in this example were light gray to off-white in color. When these solids were compression molded into square test specimens, the specimens had a smoky, faint-gray appearance. The L*a*b* value showed the sample color was improved relative to the samples of example 1 (i.e. as-received post-consumer derived polypropylene). The L* value for the sample of example 3 was 63.15 which was improved when compared to the L* values for the sample of example 1, which averaged 39.76. However, the L* value for the sample of example 3 demonstrates that the method described in EP0849312 A1 does not produce a sample that is as bright and colorless as the samples of example 2. The opacity for the sample of example 3 was 24.96% opaque, which was improved when compared to the opacity values for the samples of example 1, which averaged about 100% opaque. The opacity value also shows that the sample of example 3 was not as translucent as example 2.

The concentration of heavy metal contamination in the sample of example 3 was improved when compared to the samples of example 1, but higher in concentration when compared to the samples of example 2. The concentration of aluminum in the samples of example 3 averaged to 109,000 ppb (109 ppm). The concentration of titanium averaged to 64,100 ppb (64.1 ppm). The concentration of zinc averaged to 2,950 ppb (2.95 ppm). The concentration of sodium averaged to 5,120 ppb (5.12 ppm). The concentration of calcium averaged to 15,600 ppb (15.6 ppm). The concentration of chromium averaged to 757 ppb (0.757 ppm). The concentration of iron averaged to 55,700 ppb (55.7 ppm). The concentration of nickel averaged to 218 ppb (0.218 ppm). The concentration of copper averaged to 639 ppb (0.639 ppm). The concentration of cadmium averaged to 30.7 ppb (0.0307 ppm). The concentration of lead averaged to 121 ppb (0.121 ppm).

The sample of example 3 had an ash content of about 0.3294 wt %, which was lower than the ash content values for the samples of example 1, which averaged to about 1.2117 wt %.

The samples of example 3 had an odor intensity of 5 on a 5 point scale (5 being most intense), which was much stronger when compared to the odor intensity of the samples of example 1, which had an odor intensity of 3.75. The samples of example 3 had odor described as being like “gasoline.” The strong odor of this sample was due to the residual white sprits solvent used.

The sample of example 3 had average polyethylene content values of about 5.5 wt %, which was the same as the average polyethylene content of the samples of example lof about 5.5. wt %. Thus, the method used to prepare the composition of example 3 did not remove a significant amount of polymeric contamination.

### Example 4

A sample of reclaimed polypropylene was sourced from recycled clothing hangers. The recycled clothing hanger polypropylene originated from the United States and was predominantly natural in color. The recycled clothing hanger polypropylene was reprocessed into pellet form.

The clothing hanger polypropylene pellets were compression molded into square test specimens as disrobed herein. The L*a*b* values for the samples of example 4 show that the samples were natural in color, but not as bright as the samples of example 2. The L* for the sample of example 4 was 82.03, while the L* for the samples of example 2 averaged 85.29. The sample of example 4 was also more opaque than the samples of example 2. The opacity of the sample of example 4 was 33.96, while the opacity of the samples of example 2 averaged 7.90.

The concentration of aluminum in the samples of example 4 averaged to 59,600 ppb (59.6 ppm). The concentration of titanium averaged to 62,200 ppb (62.2 ppm). The concentration of zinc averaged to 12,100 ppb (12.1 ppm). The concentration of sodium averaged to 20,200 ppb (20.2 ppm). The concentration of calcium averaged to 119,000 ppb (119 ppm). The concentration of chromium averaged to 92.7 ppb. The concentration of iron averaged to 9,370 ppb (9.37 ppm). The concentration of nickel was below the limit of quantitation. The concentration of copper averaged to 62.9 ppb. The concentration of cadmium was below the limit of quantitation. The concentration of lead averaged to 30.1 ppb.

The sample of example 3 had an ash content of about 0.3294 wt %, which was lower than the ash content values for the samples of example 1, which averaged to about 1.2117 wt %.

The samples of example 4 had an odor intensity of 0.5 on a 5 point scale (5 being most intense). The samples of example 3 had odor described as being like “plastic.”

Any polyethylene content in the sample of example 4 was below the limit of quantitation.

TABLE 1
Color, contamination, and odor removal of Examples 1-4.

| | Example 1 | Example 2 | Example 3 | Example 4 |
|---|---|---|---|---|
| Fraction | N/A | Fraction 2 | N/A | N/A |
| Solid Media | N/A | 150 mL of silica | Fuller's | N/A |
| | | gel mixed with | Earth | |
| | | 150 mL of | | |
| | | aluminum oxide | | |
| Color L* | 39.76 ± 0.24 | 85.29 ± 0.17 | 63.15 | 82.03 |
| | (n = 3) | (n = 3) | (n = 1) | (n = 1) |
| Color a* | −2.51 ± 0.04 | −0.69 ± 0.02 | 0.27 | −1.58 |
| | (n = 3) | (n = 3) | (n = 1) | (n = 1) |
| Color b* | −1.20 ± 0.11 | 2.27 ± 0.08 | 5.79 | 3.64 |
| | (n = 3) | (n = 3) | (n = 1) | (n = 1) |
| Opacity (Y) | 100.19 ± 0.15 | 7.90 ± 0.19 | 24.96 | 33.96 |
| | (n = 3) | (n = 3) | (n = 1) | (n = 1) |
| Na (ppb) | 136,000 ± 109,000 | 2,630 ± 3130 | 5,120 ± 410 | 20,200 ± 191 |
| LOQ = 100 ppb | (n = 6) | (n = 5) | (n = 2) | (n = 3) |
| Al (ppb) | 192,000 ± 17,300 | <LOQ | 109,000 ± 2,180 | 59,600 ± 617 |
| LOQ = 1000 ppb | (n = 6) | | (n = 2) | (n = 3) |
| Ca (ppb) | 1,590,000 ± 79,500 | 2,680 ± 2,439 | 15,600 ± 312 | 119,000 ± 425 |
| LOQ = 1000 ppb | (n = 6) | (n = 5) | (n = 2) | (n = 3) |
| Ti (ppb) | 2,800,000 ± 28,000 | 638 ± 70 | 64,100 ± 135 | 62,200 ± 597 |
| LOQ = 100 ppb | (n = 6) | (n = 5) | (n = 2) | (n = 3) |
| Cr (ppb) | 4,710 ± 612 | 17.5 ± 20.5 | 757 ± 204 | 92.7 ± 1.12 |
| LOQ = 10 ppb | (n = 6) | (n = 5) | (n = 2) | (n = 3) |
| Fe (ppb) | 108,000 ± 1,080 | <LOQ | 55,700 ± 557 | 9,370 ± 2,849 |
| LOQ = 1000 ppb | (n = 6) | | (n = 2) | (n = 3) |
| Ni (ppb) | 1,160 ± 151 | 10.9 ± 7.3 | 218 ± 0.196 | <LOQ |
| LOQ = 10 ppb | (n = 6) | (n = 5) | (n = 2) | |
| Cu (ppb) | 15,300 ± 612 | 33.0 ± 17.2 | 639 ± 345 | 62.9 ± 6.00 |
| LOQ = 10 ppb | (n = 6) | (n = 5) | (n = 2) | (n = 3) |
| Zn (ppb) | 71,000 ± 1,420 | 261 ± 183 | 2,950 ± 443 | 12,100 ± 301 |
| LOQ = 10 ppb | (n = 6) | (n = 5) | (n = 2) | (n = 3) |
| Cd (ppb) | 1,620 ± 113 | <LOQ | 30.7 ± 1.23 | <LOQ |
| LOQ = 10 ppb | (n = 6) | | (n = 2) | |
| Pb (ppb) | 12,200 ± 243 | <LOQ | 121 ± 0.061 | 30.1 ± 1.04 |
| LOQ = 10 ppb | (n = 6) | | (n = 2) | (n = 3) |
| Ash Content | 1.2117 ± 0.1501 | 0.2897 ± 0.1533 | 0.3294 ± 0.0948 | 0.3706 ± 0.0905 |
| (% res from TGA) | (n = 3) | (n = 3) | (n = 3) | (n = 2) |
| Odor Intensity | 3.75 | 0.5 | 5 | 0.5 |
| (0-5) | | | | |
| Odor Descriptor | garbage, | plastic, | gasoline | plastic |
| | dusty, sour | gasoline | | |
| PE content (wt %) | 5.5 ± 0.3% | <LOQ | 5.5 ± 0.1% | <LOQ |
| DSC method | (n = 3) | | (n = 3) | |
| LOQ = 1% | | | | |

### Virgin Polypropylene Comparative Samples

Pro-fax 6331 polypropylene (LyondellBasell Industries Holdings, B.V.) was used for all “Virgin PP” comparative samples. The pellets of virgin PP were processed into square test specimens according the method described herein. The L*a*b* values for the specimens made from virgin PP averaged to 85.13±0.18, −0.71±0.01, and 2.27±0.02, respectively The square test specimens had an average opacity of 7.56±0.21% opaque. The pellets of virgin PP had an odor intensity of 0.5 on a 5 point scale (5 being the most intense) and had odor described as being like “plastic.”

Every document cited herein, including any cross reference or related patent or patent application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggest or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modification can be made without departing from the spirit and scope of the invention. It is therefore intended to cover in the appended claims all such changes and modification that are within the scope of the present invention.

What is claimed is:

1. A composition comprising at least about 95 weight percent reclaimed polypropylene comprising:
a. less than about 10 ppm Al;
b. less than about 5 ppm Ti; and
c. less than about 5 ppm Zn;
wherein said reclaimed polypropylene has a contrast ratio opacity of less than about 15% and said composition is substantially free of odor.

2. A composition according to claim 1, wherein the reclaimed polypropylene is post consumer recycle derived reclaimed polypropylene.

3. A composition according to claim 1, wherein the reclaimed polypropylene is post-industrial recycle derived reclaimed polypropylene.

4. A composition according to claim 1 said reclaimed polypropylene comprises less than about 10 ppm Na.

5. A composition according to claim 1 said reclaimed polypropylene comprises less than about 20 ppm Ca.

6. A composition according to claim 1 said reclaimed polypropylene comprises less than about 2 ppm Cr.

7. A composition according to claim 1 said reclaimed polypropylene comprises less than about 7 ppm Fe.

8. A composition according to claim 1 said reclaimed polypropylene comprises less than about 100 ppb Ni.

9. A composition according to claim 1 said reclaimed polypropylene comprises less than about 50 ppb Cu.

10. A composition according to claim 1 said reclaimed polypropylene comprises less than about 10 ppb Cd.

11. A composition according to claim 1 said reclaimed polypropylene comprises less than about 10 ppb Pb.

12. A composition according to claim 1 said reclaimed polypropylene has a contrast ratio opacity of less than about 10%.

13. A composition according to claim 1 having an odor intensity less than about 2.
